(19) United States
(12) Patent Application Publication
(10) Pub. No.: US 2002/0088409 A1
(43) Pub. Date: Jul. 11, 2002

(54) Bird cage structure

(76) Inventor: Candy Huang, Taipei (TW)

Correspondence Address: BACON & THOMAS, 625 Slaters Lane - 4th Floor, Alexandria, VA, 22314, US

(21) Appl. No.: 09/754,332

(22) Filed: Jan. 5, 2001

(51) Int. Cl. A01K 31/06

(52) U.S. Cl. 119/459

(57) ABSTRACT

An improved bird cage structure includes a pair of symmetric right and left grid frames, a pair of symmetric front and rear grid frames, a top grid frame and a bottom grid frame. The right and left grid frames have respectively latch elements extended outward to engage with the top grid frame and fastening elements disposed at selected locations for fastening the engaging elements located at the front and rear grid frames to form a sturdy bird cage. The grid frames have respectively a slot opening to hold a slant chute for forming a collection trough. The cage may be detached easily to single pieces and packed to a small size, and can be transported conveniently at a lower cost.

### BACKGROUND OF THE INVENTION

This invention relates to a bird cage and particularly an improved bird cage that has a sturdy structure and is detachable, and is easy to disassemble for packing to small size to facilitate transportation at a lower cost.

A lot of people feel great pressure under the highly competitive and demanding working environments in modern time, and are eager to get a hobby to relax after working hours. Keeping pet birds is a pastime many people enjoy. Bird cage is an essential item for keeping pet birds. Most bird cages now available in the market place are assembled by grid frames which usually take a relatively large size after assembly. Assembly and disassembly of the bird cage is quite tedious and time-consuming. Hence many bird cages are sold in the assembled forms. Packaging and transportation of the huge volume of the bird cages become quite expensive and not convenient. There are detachable bird cages being developed and introduced to address this problem. FIG. 1 shows a conventional detachable bird cage which includes grid frames that may be disassembled and packed to a smaller size, and a tray which still occupies a large volume and cannot be packed to a smaller size. It still costs a lot for transportation. Applicant has developed an improved bird cage and obtained a patent in Taiwan (Application No. 88206291, Taiwan, ROC). While it has improvements over the conventional bird cages, there are still rooms for enhancement.

### SUMMARY OF THE INVENTION

It is therefore an object of this invention to provide an improved bird cage that is sturdily built and may be detached easily to single pieces and packed to a small size, and can be transported conveniently at a lower cost.

In one aspect, the bird cage according to this invention includes a pair of symmetric right and left grid frames, a pair of symmetric front and rear grid frames, a top grid frame and a bottom grid frame. The right and left grid frames have respectively latch elements extended outward to engage with the top grid frame and fastening elements disposed at selected locations for fastening engaging elements located at the front and rear grid frames to form sturdy side frames of the bird cage. The front grid frame has a slot opening at a lower section for the bottom grid frame to slide through. When the bird cage is assembled and erected, a slant chute may be disposed respectively at the side grid frames at a selected location and engaged with each other to form a collection trough.

### BRIEF DESCRIPTION OF THE DRAWINGS

The invention, as well as its many advantages, may be further understood by the following detailed description and drawings, in which:

FIG. 1 is a perspective view of a conventional bird cage.

FIG. 2 is a perspective view of this invention.

FIG. 3A is an exploded view of this invention.

FIG. 3B is a fragmentary enlarged view of this invention shown in FIG. 3A.

FIG. 4 is a fragmentary perspective view of this invention.

FIG. 5A is an exploded view of a bottom grid frame of this invention.

FIG. 5B is an enlarged fragmentary perspective view of the chutes shown in FIG. 5A.

FIG. 6 is another perspective view of this invention.

FIG. 7 is a perspective view of an embodiment of this invention.

FIG. 8 is a fragmentary exploded view of a foot strut shown in FIG. 7.

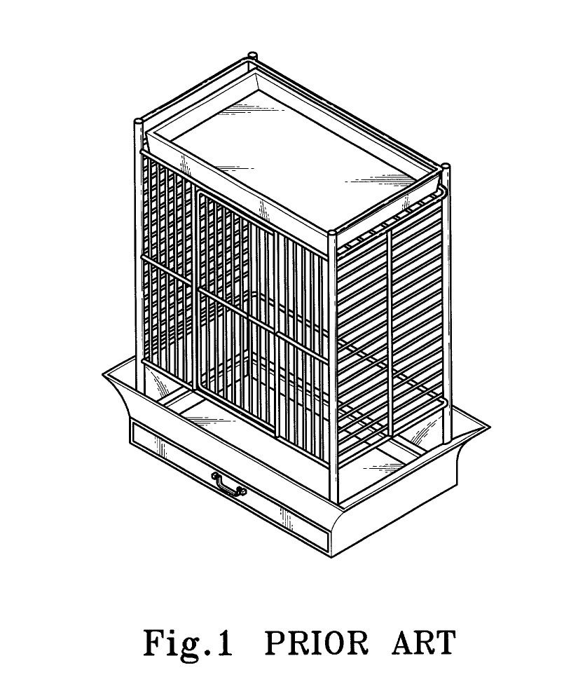

### DESCRIPTION OF THE PREFERRED EMBODIMENT

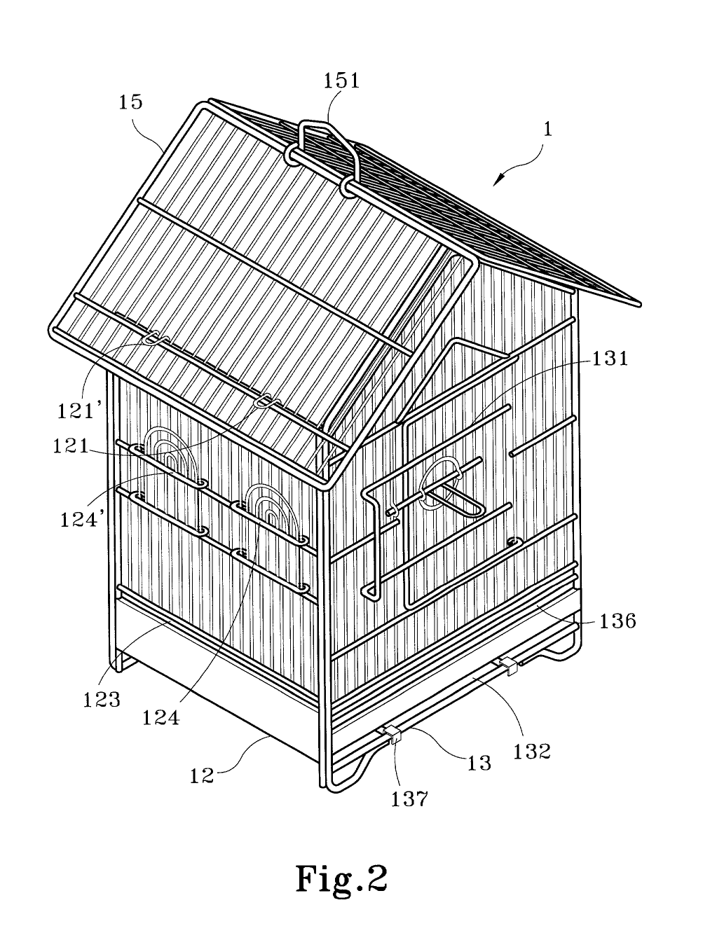

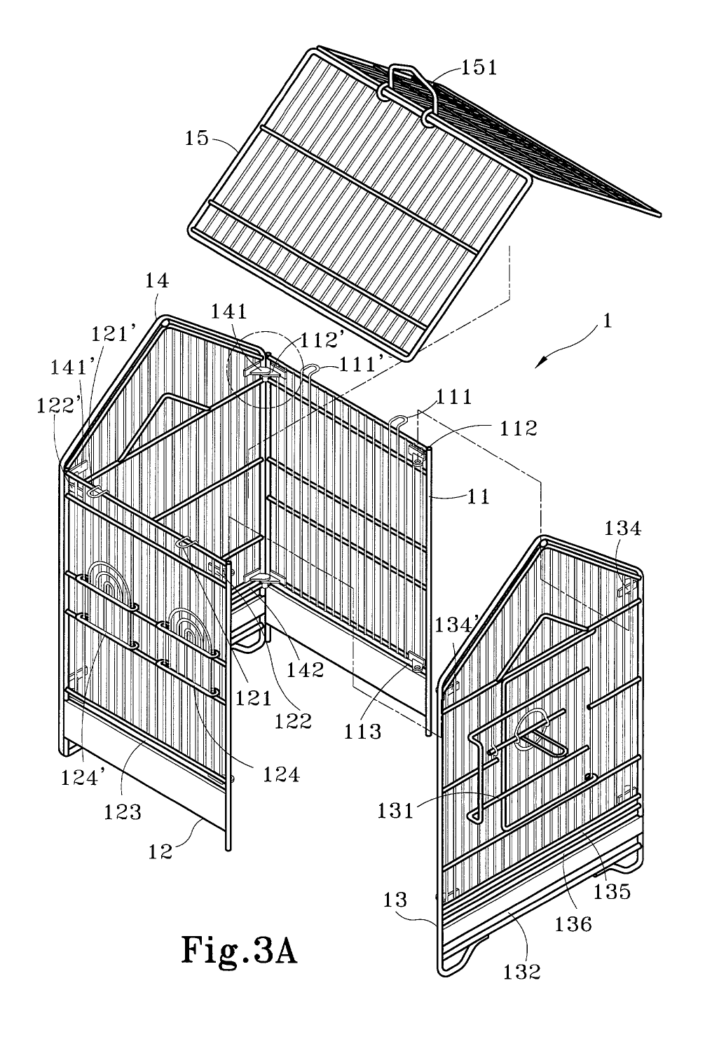

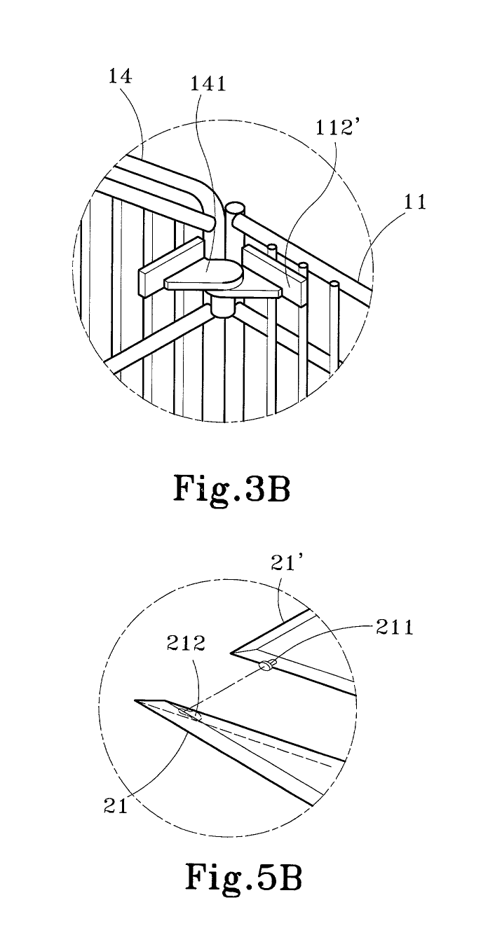

Referring to FIGS. 2, 3A and 3B, the bird cage 1 according to this invention includes a right grid frame 11 and a left grid frame 12 symmetrical to each other, a front grid frame 13 and a rear grid frame 14 symmetrical to each other, and a top grid frame 15. The front grid frame 13 has a door 131. The top grid frame 15 has a handle 151 disposed at a selected location. The right and left grid frame 11 and 12 have respectively latch elements 111, 111′, 121, and 121′ located at one side and extended outward for engaging with the top grid frame 15. The right or left grid frame 11 (or 12) further has slide doors 124 and 124′ for holding cups 4. The right and left grid frame I1 and 12 also have respectively fastening elements 112, 112′ 122, and 122′ disposed at selected locations. The front and rear grid frame 13 and 14 have respectively engaging elements 134, 134′, 141 and 141′ for engaging respectively with the fastening elements 112, 112′ 122, and 122′. Hence the cage 1 may be easily disassembled to a plurality of single pieces and packed to small size for transportation at a low cost, and also may be assembled easily to become a sturdy cage.

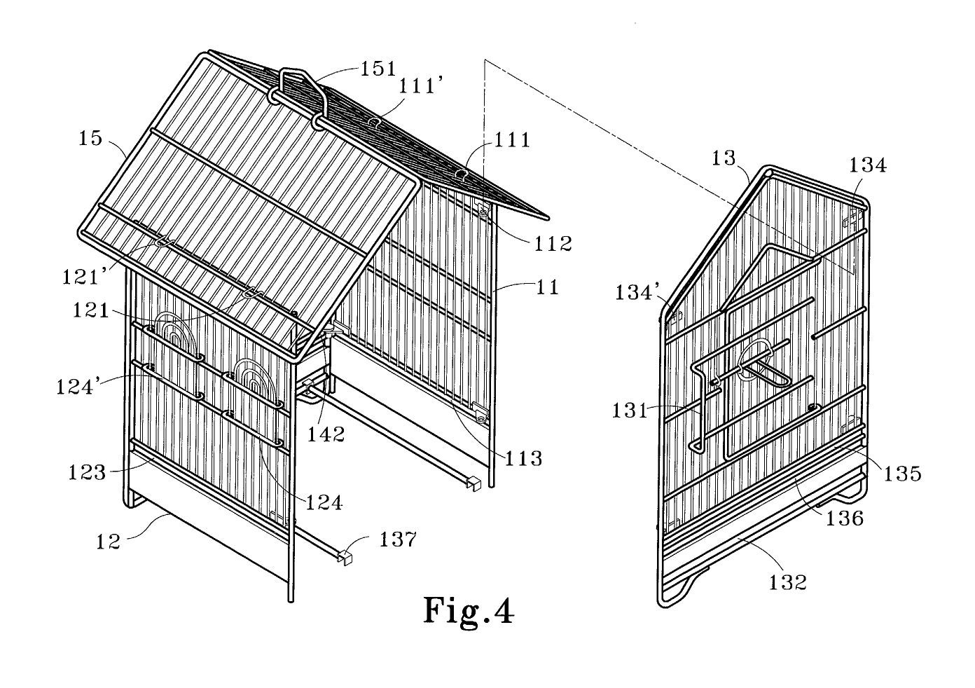

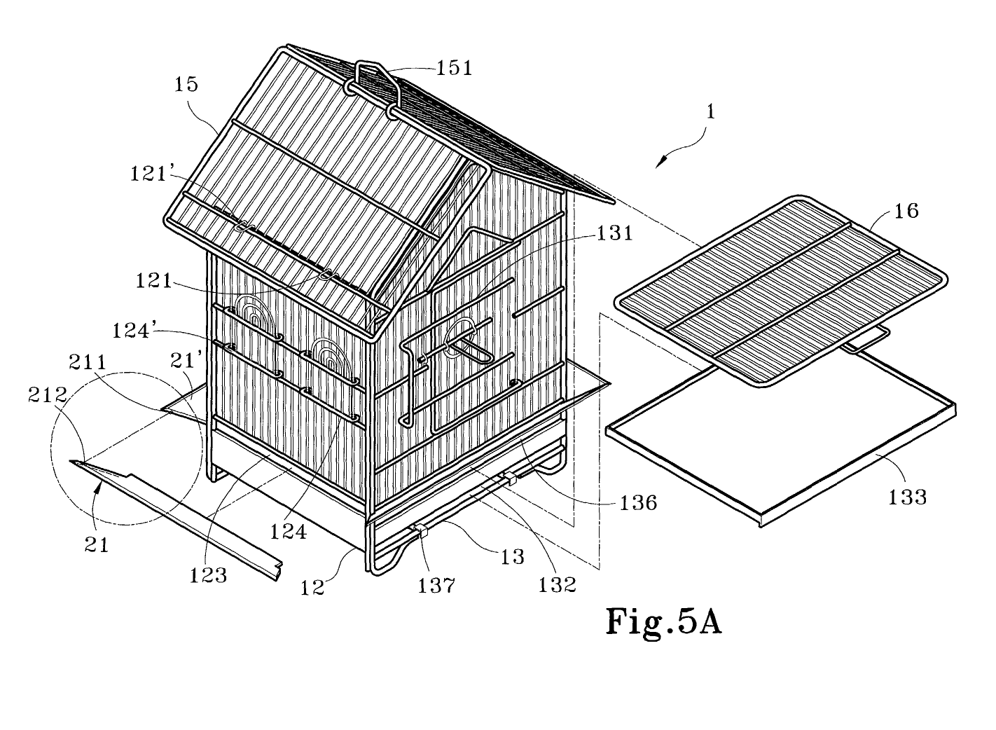

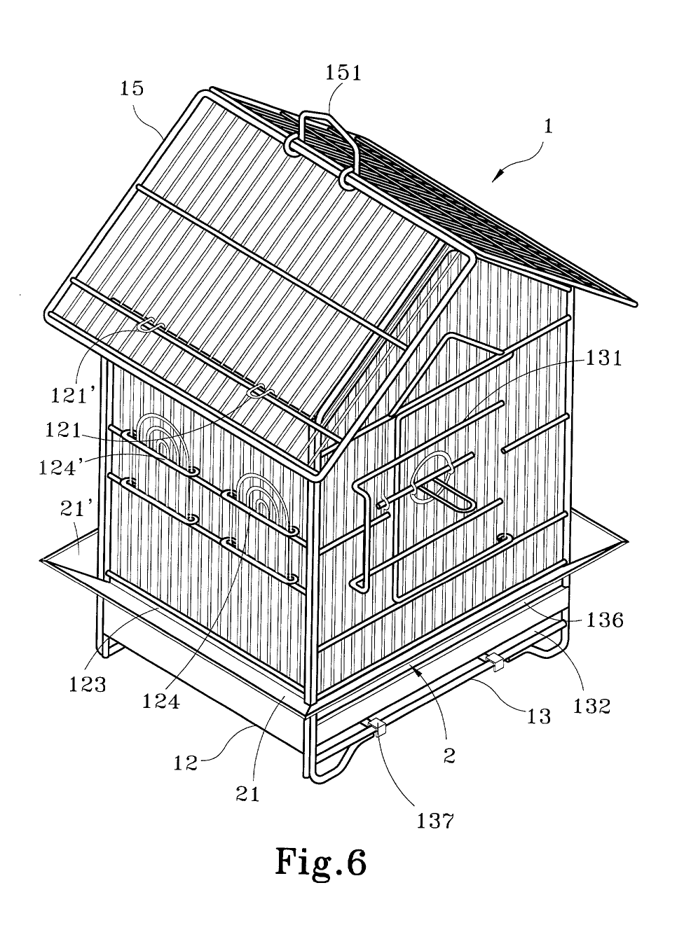

Referring to FIGS. 4, 5A, 5B, and 6, the right, left, front and rear grid frames 11,12,13 and 14 have respectively a slot opening 113, 123, 135 and 142 located at a lower section thereof for holding a slant chute 21 and 21′. The chute 21 has a fastening aperture 212 for engaging with a fastening element 211 at another chute 21′ to form a collection trough 2 which has an upward opening. The front grid frame 13 further has a second slot opening 136 located beneath the slot opening 135. The second slot opening 136 enables a bottom grid frame 16 to slide therethrough and forms a holding space 132 at a lower section of the front grid frame 13 to hold a tray 133 for collecting and disposing bird dropping, bird feeds, dropping feather or the like to maintain clean and neat conditions. The front and rear grid frames (13,14) further have a plurality of support bars 137 to reinforce the cage structure.

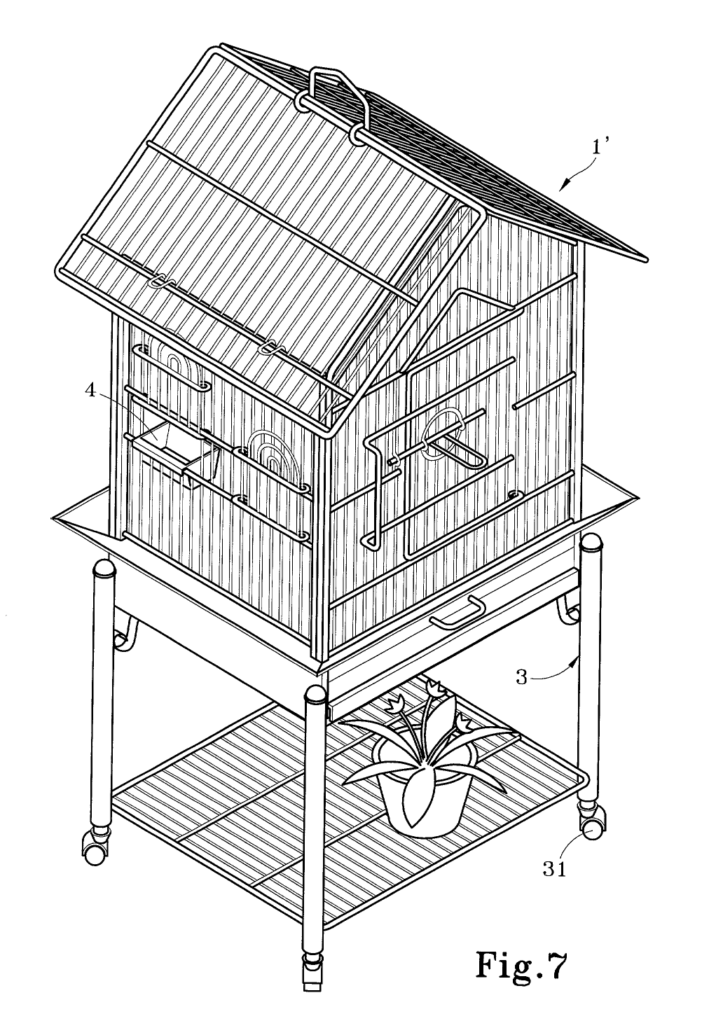

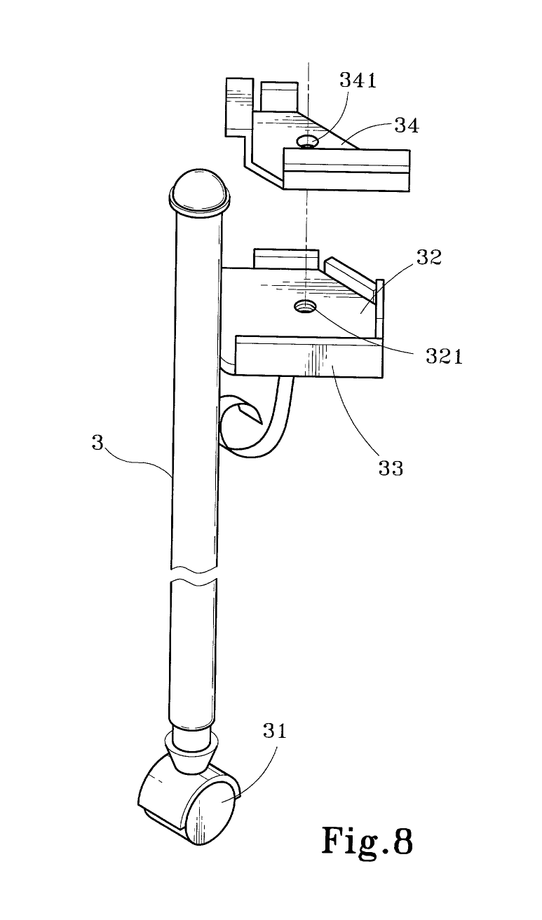

FIGS. 7 and 8 show an embodiment of this invention. A relatively large size bird cage 1′ is supported by a plurality of foot struts 3 located below so that the cage 1′ will be lifted to a height desired. At the top end of each foot strut 3, there is a fastening member 32 which has a plurality of upward flanges 33 and a clamp element 34. The fastening member 32 and clamp 34 have respectively a holding bore 321 and 341 formed therein for fastening the bottom side of the bird cage 1′ securely. The bottom end of the foot strut 3 may engage with a caster 31 to facilitate moving of the bird cage 1′.

Through the construction set forth above, this invention offers an improved bird cage that is sturdily built and may be assembled and disassembled easily and rapidly. The disassembled cage will become a plurality of single piece elements and may be packed to small size to facilitate transportation or carrying.

What is claimed is:

1. A bird cage structure having a cage constructed by a plurality of symmetrical grid frames, comprising:
a right grid frame having latch elements located at one side and fastening elements located at two ends thereof;
a left grid frame having latch elements located at one side and fastening elements located at two ends thereof;
a front grid frame having engaging elements engageable with the fastening member of the right and left grid frame;
a rear grid frame having engaging elements engageable with the fastening member of the right and left grid frame;
a top grid frame located above the right and left grid frames and engageable with the latch members; and
a bottom grid frame slidably located below the front frame;
wherein the grid frames are capable of being assembled to form a complete structure and are detachable to single pieces for packing and transportation.

2. The bird cage structure of claim 1, wherein the right, left, front and rear grid frames have respectively a slot opening located at a lower section thereof for holding a slant chute, the chute having a fastening aperture and a fastening element located at two ends thereof for engaging with each other whereby to form a collection trough.

3. The bird cage structure of claim 1, wherein the right or left grid frame has two symmetrical slide doors for holding a plurality of cups.

4. The bird cage structure of claim 1, wherein the front and rear grid frames have respectively a plurality of support bars for reinforcing the cage structure.

5. The bird cage structure of claim 1, wherein the front grid frame has a door opening and a holding space at a lower section thereof for holding a tray.

6. The bird cage structure of claim 1, wherein the top grid frame has a handle disposed at a selected location.

7. The bird cage structure of claim 1 further having a plurality of foot struts located below the cage, each foot strut having a fastening member which has a plurality of upward flanges and a clamp element for fastening the bottom side of the bird cage securely, and a caster located at the bottom end thereof.

8. The bird cage structure of claim 7, wherein the fastening member and clamp element has respectively a holding bore formed therein.
